(19) United States
(12) Patent Application Publication
(10) Pub. No.: US 2026/0270101 A1
(43) Pub. Date: Sep. 10, 2026

(54) ADAPTIVE NETWORK PATH SELECTION FOR VIRTUAL MEETING OPTIMIZATION

(71) Applicant: Citrix Systems, Inc., Fort Lauderdale, FL (US)

(72) Inventors: Jigao Huang, Nanjing (CN); Jintang Wu, Nanjing (CN); Lei Jin, Nanjing (CN); Yajun Yao, Nanjing (CN)

(21) Appl. No.: 18/873,504

(22) PCT Filed: Sep. 22, 2022
(86) PCT No.: PCT/CN2022/120470

§ 371 Date: Dec. 10, 2024

(51) Int. Cl. H04L 12/18; H04L 65/80; H04W 36/30

(52) U.S. Cl. CPC H04L 12/1827; H04L 65/80; H04W 36/304

(57) ABSTRACT

Methods and apparatus for improving performance in a virtual meeting session in a distributed workspace system. One example includes transmitting media data for the virtual meeting session over an active network connection between first and second computing devices, determining a first quality score for the active network connection based on parameter(s) associated with the active network connection, periodically transmitting test data over a standby network connection between the first and second computing devices, determining a second quality score for the standby network connection based on parameter(s) associated with the standby network connection, based on the second quality score exceeding the first quality score by a first threshold, determining standby network quality based on latency conditions associated with the standby network connection, and if the standby network quality exceeds a second threshold, switching the active and standby network connections and transmitting the media data over the new active network connection.

### RELATED APPLICATIONS

This application claims the benefit of and is a National Stage Filing under 35 U.S.C. § 371 of International Patent Cooperation Treaty (PCT) Application No. PCT/CN2022/120470 (filed Sep. 22, 2022), which is incorporated here by reference in its entirety.

### BACKGROUND

Virtual collaboration products are computer-implemented tools that facilitate online sharing and exchange of audio, video, and other types of data between users. One of the most common types of virtual collaboration is a virtual meeting, where multiple attendees, or participants, can communicate with each other in real-time through an audio/video conference even when the participants are not physically situated in the same location.

### SUMMARY

Aspects and embodiments are directed to methods and apparatus for improving virtual meeting experiences, and in particular, to monitoring network connection conditions between meeting participants and dynamically switching between different available network paths to improve latency and/or other network conditions, when necessary, and thereby provide enhanced video and/or audio performance for meeting participants.

According to one embodiment, a method of improving performance in a virtual meeting session in a distributed workspace system comprises transmitting media data corresponding to the virtual meeting session over an active network connection between first and second computing devices corresponding, respectively, to first and second meeting participants in the virtual meeting session, wherein the first computing device is part of the distributed workspace system, determining a first quality score for the active network connection based on one or more first parameters associated with the active network connection, periodically transmitting test data over a standby network connection between the first and second computing devices, determining a second quality score for the standby network connection based on one or more second parameters associated with the standby network connection, and based on determining that the second quality score exceeds the first quality score by at least a first predetermined threshold value: determining an indication of standby network quality based on latency conditions associated with the standby network connection, and based on the indication of the standby network quality exceeding a second predetermined threshold value, switching the active and standby network connections such that the standby network connection becomes a new active network connection and the active network connection becomes a new standby network connection, and transmitting the media data over the new active network connection.

The method may further comprise accessing the virtual meeting session on the first computing device, including accessing a virtual machine through a digital workspace application running on the first computing device, the virtual machine hosting a virtual meeting application configured to connect the first meeting participant to the virtual meeting session.

In one example, the active network connection corresponds to one of either a direct network path between the first and second computing devices or an indirect network path between the first and second computing devices, and wherein the standby network connection corresponds to the other of the direct network path and the indirect network path, and the indirect network path comprises a combination of a first network path between the first computing device and the virtual machine and a second network path between the virtual machine and the second computing device. In one example, determining the first quality score comprises monitoring the one or more first parameters during the virtual meeting session. In another example, monitoring the one or more first parameters comprises monitoring at least one of frames per second of the media data transmitted over the active network connection, resolution of the media data transmitted over the active network connection, packet loss rate associated with the media data transmitted over the active network connection, a network round-trip time for the active network connection, or processor load for at least one processor of the distributed workspace system. In another example, when the active network connection corresponds to the direct network path, monitoring the one or more first parameters includes monitoring the processor load for a processor of the first computing device.

In one example, determining the second quality score comprises monitoring the one or more second parameters during periodic transmission of the test data over the standby network connection. In another example, monitoring the one or more second parameters comprises monitoring at least one of frames per second of the test data transmitted over the standby network connection, resolution of the test data transmitted over the standby network connection, packet loss rate associated with the test data transmitted over the standby network connection, a network round-trip time for the standby network connection, or processor load for at least one processor of the distributed workspace system. In another example, when the standby network connection corresponds to the indirect network path, monitoring the one or more second parameters includes at least one of monitoring network round-trip time between the virtual machine and the second computing device, the processor load for at least one processor operating the virtual machine, or network round-trip time between the first computing device and the virtual machine.

In one example, determining the indication of standby network quality based on the latency conditions associated with the standby network connection comprises measuring a round-trip network connection time of the standby network connection during periodic transmission of the test data over the standby network connection.

In one example, the test data is a copy of the media data.

In another example, the media data corresponding to the virtual meeting session comprises at least one of video data or audio data.

Another embodiment is directed to a distributed computer system configured to implement methods according to any of the examples discussed above.

According to another embodiment, a distributed computer system comprises a memory storing a plurality of instructions, at least one network interface, and at least one processor coupled to the memory and to the at least one network interface and configured execute the plurality of instructions to: operate a virtual meeting session, establish, via the at least one network interface, an active network connection between a first computing device of the distributed computer system and a peer computing device, transmit, via the active network connection, media data corresponding to the virtual meeting session from the first computing device to the peer computing device, determine a first quality score for the active network connection based on one or more first parameters associated with the active network connection, periodically establish a standby network connection between the first computing device and the peer computing device, transmit test data over the standby network connection, determine a second quality score for the standby network connection based on one or more second parameters associated with the standby network connection, and based on determining that the second quality score exceeds the first quality score by at least a first predetermined threshold value: determine an indication of standby network quality based on latency conditions associated with the standby network connection, and based on the indication of the standby network quality exceeding a second predetermined threshold value, (i) establish the standby network connection as a new active network connection between the first computing device and the peer computing device, (ii) disable the active network connection, and (iii) transmit, via the new active network connection, the media data corresponding to the virtual meeting session from the first computing device to the peer computing device.

In one example, to operate the virtual meeting session, the first computing device is configured to access a virtual machine through a digital workspace application running on the first computing device, the virtual machine hosting a virtual meeting application. In another example, the active network connection corresponds to one of either a direct network path between the first computing device and the peer computing device or an indirect network path between the first computing device and the peer computing device, and wherein the standby network connection corresponds to the other of the direct network path and the indirect network path, wherein the indirect network path comprises a combination of a first network path between the first computing device and the virtual machine and a second network path between the virtual machine and the second computing device. In another example, to determine the first quality score the at least one processor is configured to monitor the one or more first parameters during the virtual meeting session. In another example, to monitor the one or more first parameters the at least one processor is configured to monitor at least one of frames per second of the media data transmitted over the active network connection, resolution of the media data transmitted over the active network connection, packet loss rate associated with the media data transmitted over the active network connection, a network round-trip time for the active network connection, or a computing load on the at least one processor.

In one example, to determine the second quality score the at least one processor is configured to monitor the one or more second parameters during transmission of the test data over the standby network connection. In another example, to monitor the one or more second parameters the at least one processor is configured to monitor at least one of frames per second of the test data transmitted over the standby network connection, resolution of the test data transmitted over the standby network connection, packet loss rate associated with the media data transmitted over the standby network connection, a network round-trip time for the standby network connection, or a computing load on the at least one processor during temporary transmission of the media data over the standby network connection. In another example, when the standby network connection corresponds to the indirect network path, to monitor the one or more second parameters the at least one processor is configured to monitor network round-trip time between the virtual machine and the peer computing device and network round-trip time between the first computing device and the virtual machine.

In one example, to determine the indication of standby network quality based on the latency conditions associated with the standby network connection, the at least one processor is configured to determine a round-trip network connection time of the standby network connection during periodic transmission of the test data over the standby network connection.

In one example, the test data is a copy of the media data.

In another example, the media data corresponding to the virtual meeting session comprises at least one of video data or audio data.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, each identical or nearly identical component that is illustrated is represented by a like reference numeral. For purposes of clarity, every component may not be labeled in every figure. In the figures:

FIG. 1 is a logical block diagram of one example of an implementation of a virtual meeting application in a distributed workspace system according to various aspects disclosed herein;

FIG. 2A is a diagram illustrating one example of data flow for a virtual meeting session;

FIG. 2B is a diagram illustrating another example of data flow for a virtual meeting session;

FIG. 3 is a diagram illustrating an example of data flow for improved virtual meeting performance according to various aspects disclosed herein;

FIG. 4 is a flow diagram of one example of a method of improving virtual meeting performance according to various aspects disclosed herein;

FIG. 5 is a block diagram of an example of a distributed computing system for implementing improved virtual meeting performance in accordance with examples disclosed herein; and

FIG. 6 is a logical block diagram of a computing device configured to implement various systems and processes in accordance with examples disclosed herein.

### DETAILED DESCRIPTION

Virtual collaboration products, and particularly virtual meeting applications, are widely used, often to connect people in very distant geographic locations. For example, virtual meetings can have participants who are physically located in different cities, different states/provinces, or even different countries. Generally, a cloud-based server is used to establish and control the network connections between the computing devices on which each participant is running their virtual meeting application. Although various software tools and protocols are designed to support communication channels providing high quality audio and video for virtual meetings, there are still circumstances in which one or more participants experience degraded communication performance, such as delays in the audio and/or video, or poor sound and/or picture quality.

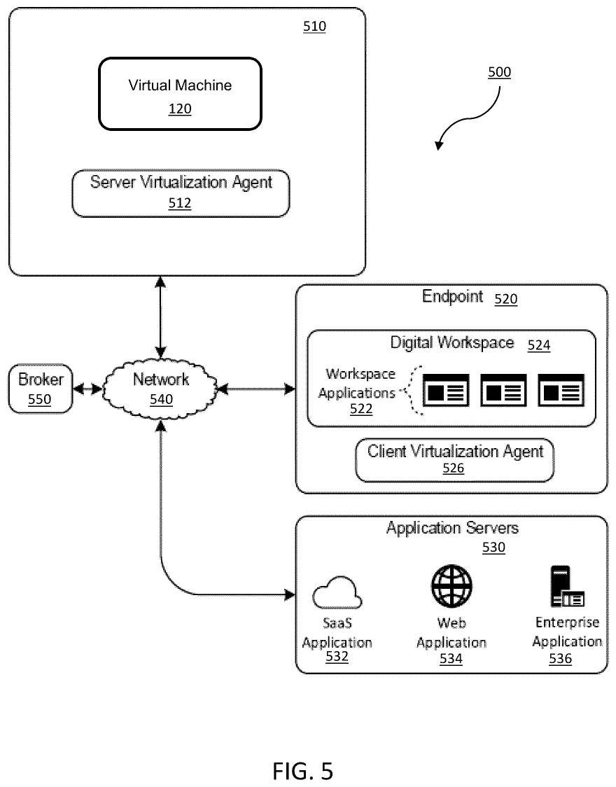

In some instances, one or more participants in a virtual meeting session may access their virtual meeting application via a virtual machine and virtual workspace hosted in a distributed computing system, such as the system 500 discussed below with reference to FIG. 5. In some examples, a distributed computing system is configured to implement workspace and system access to remote users, thereby providing a central repository of applications, files, and other similar resources to a group of trusted users accessible via, for example, an enterprise service. A distributed workspace can be implemented as a software platform designed to deliver and manage a user's applications, data, and desktops in a consistent and secure manner, regardless of the user's device or location. A distributed workspace allows users to access functionality provided by multiple enterprise applications, including, for example, software as a system (SaaS) applications, web applications, desktop applications, and proprietary applications, through a single interface.

Aspects and embodiments are directed to systems and methods for improving virtual meeting performance where at least one meeting participant is accessing their virtual meeting session using a distributed workspace. In particular, aspects and embodiments provide for monitoring network conditions between a client device (also referred to as an endpoint or endpoint device), a virtual machine coupled to the endpoint, and one or more peer computing devices (corresponding to other meeting participants), and dynamically and seamlessly switching between different available network paths based on the network conditions, and optionally on a computing load being handled either the endpoint device or the virtual machine. In this manner, the system can adapt to conditions in the distributed computing system and in its network connections to other computing devices, to provide optimized virtual meeting session performance based on the available resources and conditions.

For example, according to one embodiment, a method of improving performance in a virtual meeting session in a distributed workspace system comprises transmitting media data corresponding to the virtual meeting session over an active network connection between first and second computing devices corresponding, respectively, to first and second meeting participants in the virtual meeting session, wherein the first computing device is part of the distributed workspace system, determining a first quality score for the active network connection based on one or more first parameters associated with the active network connection, periodically transmitting test data over a standby network connection between the first and second computing devices, and determining a second quality score for the standby network connection based on one or more second parameters associated with the standby network connection. The method further comprises, based on determining that the second quality score exceeds the first quality score by at least a first predetermined threshold value, determining an indication of standby network quality based on latency conditions associated with the standby network connection, and based on the indication of the standby network quality exceeding a second predetermined threshold value, switching the active and standby network connections such that the standby network connection becomes a new active network connection and the active network connection becomes a new standby network connection, and transmitting the media data over the new active network connection.

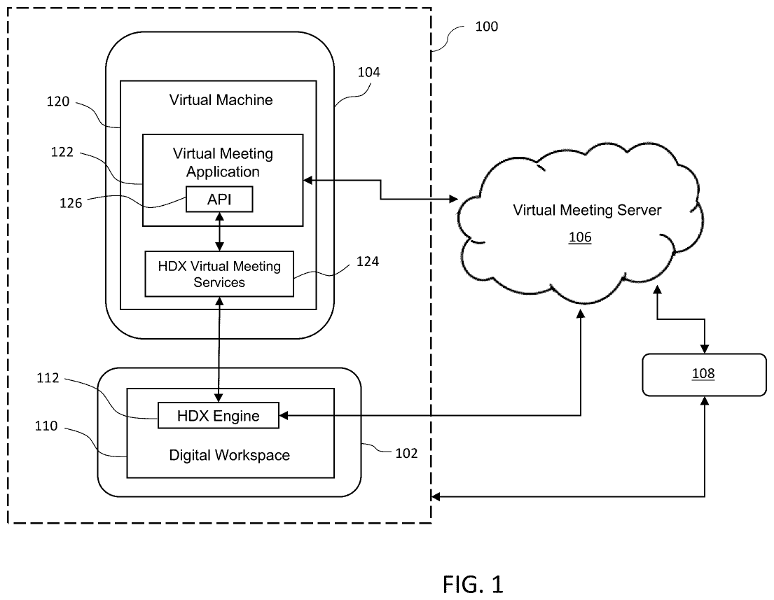

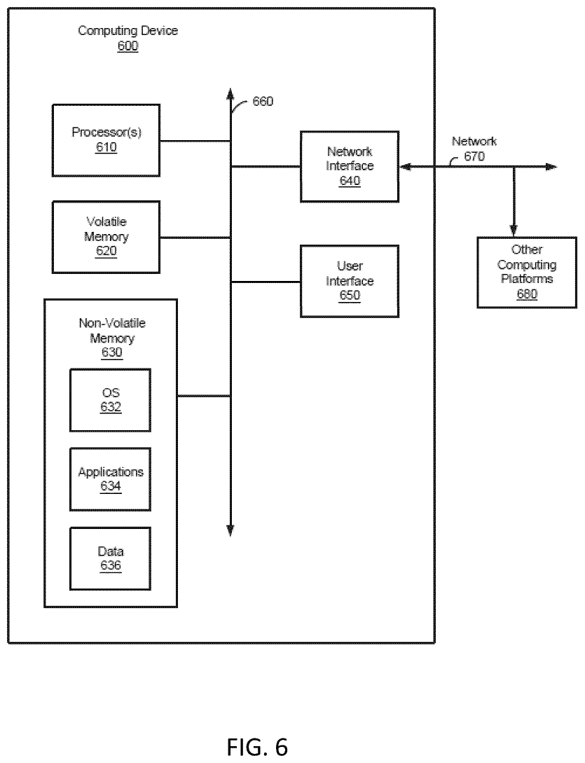

Referring to FIG. 1, there is illustrated a logical architecture of one implementation of components for operating a virtual meeting application, such as, but not limited to Microsoft Teams®, in a distributed workspace system, such as the system 500 discussed below with reference to FIG. 5, for example. In the example of FIG. 1, a distributed computing system 100 includes an endpoint 102 that is operably coupled to an in communication with a virtualization environment 104. The endpoint 102 may be a computing device, such as the computing device 600 discussed below with reference to FIG. 6, for example, that is used by a user. Various examples of suitable computing devices for the endpoint 102 include, but are not limited to, a desktop computer, a laptop computer, a tablet computer, or a smartphone.

The endpoint 102 is configured to execute a virtual desktop application, also referred to as a digital workspace app 110, such as the Citrix Workspace™ application, which may include an embedded browser, and a virtualization agent. The digital workspace app 110 can be configured to provide an interface to allow remote access to one or more resources hosted at or by the virtualization environment 104. An example of the digital workspace app 110 can include the digital workspace 524 of the example of FIG. 5. The digital workspace app 110 may allow the user to access any of a variety of workspace applications, such as the workspace applications 530 of the example of FIG. 5 discussed below.

The virtualization environment 104 may comprise one or more remote computing devices, configured to host shared resources that can be made accessible to the endpoint 102. In certain examples, the virtualization environment 104 may include one or more cloud servers, data centers, gateways, rack servers, and/or other physical and/or virtual computing resources. The virtualization environment 104 may include any combination of hardware and software computing components and/or resources that can be configured to execute, operate, or otherwise provide various applications and services to enable and support the digital workspace app 110. As shown in FIG. 1, the virtualization environment 104 can be configured to execute a virtual machine 120 providing access to a computing environment to a user of the endpoint 102. The virtual machine 120 can be implemented using a variety of resources and virtualization infrastructure within the virtualization environment 104, including, for example, the High-Definition User Experience (HDX) virtualization infrastructure commercially available from Citrix Systems of Fort Lauderdale, Fla.

According to certain examples, the virtual machine 120 may host a variety of applications, including a virtual meeting application 122 configured to provide a virtual collaboration or meeting environment. For example, the virtual meeting application 122 may support one or more sessions for any virtual meeting platform such as GoToMeeting®, Skype®, Slack®, Google Hangouts®, Zoom®, Microsoft Teams®, Google® Meeting, Cisco WebEx®, or other computer software configured to create, host, and deliver online conferences, meetings, demonstrations, tours, presentations, and discussions among multiple participants, including organizers and attendees. In certain examples, the virtual meeting application 122 can be hosted by the virtual machine 120 and accessed by a user of the endpoint 102 through the digital workspace app 110. The virtualization environment 104 and the digital workspace app 110 together provide the infrastructure and services for the user of the endpoint device 102 to access and interact with the virtual meeting application 122, which in certain examples may be accessed using the (HDX)/ICA remoting protocol.

According to certain examples, a virtual meeting session can be optimized using HDX services 124, which are implemented within the virtual machine 120, as shown in FIG. 1. The HDX services 124 can interoperate with the virtual meeting application 122 via an application programming interface (API) 126 that exposes features of the virtual meeting application 122 through one or more API calls. A corresponding HDX engine 112 within the digital workspace app 110 can coordinate with the HDX services 124 in the virtual machine 120 to control, and attempt to optimize, the audio and video performance of the virtual meeting, as discussed further below. A user of the endpoint device 102 can access the virtual meeting application 122 via the digital workspace app 110. The virtual machine 120 and the HDX engine 112 communicate with a virtual meeting server 106 (e.g., one of the application servers 530 discussed below with reference to FIG. 5) to exchange data and perform various functions to operate the virtual meeting, such as: authenticating the user to grant access to the virtual meeting session; signaling (e.g., indicating that a user has joined the virtual meeting); enabling messaging within the virtual meeting session; and allowing for audio and/or video media exchange and screensharing among participants in the virtual meeting. In certain examples, the hosted virtual meeting application 122 is an agent or client application that is executed on the virtual machine 120 and presented to a user of the endpoint device through the digital workspace app 110, as discussed above, and communicates with a virtual meeting service that is hosted by the virtual meeting server 106 (such as a Microsoft Azure server, for example). One or more other meeting participants in the virtual meeting session may similarly access the virtual meeting server 106 from corresponding computing devices 108. The computing device(s) 108 may be any type of suitable computing device, such as the computing device 600 of FIG. 6, for example, and may or may not be a distributed computing system. During a virtual meeting session, in addition to communicating with the virtual meeting server 106, the computing devices 100 and 108 associated with participants in the virtual meeting session may also communicate with one another, as shown in FIG. 1, to exchange audio and/or video data supporting the virtual meeting session, as discussed further below.

When a virtual meeting session is initiated, the virtual meeting application 122 selects and connects to a virtual meeting server 106. The virtual meeting application 122 may go through any necessary authentication procedures and establish necessary communications policies and setup one or more signaling channels. The HDX meeting services 124 may make calls to the API 126 to establish connections and communications with the virtual meeting application 122 and the HDX engine 112 Through the virtual meeting server 106, end-to-end signaling paths can be established between meeting participants. A host participant may establish a series of supported call parameters (codecs, resolutions, and so forth, which is known as a Session Description Protocol (SDP) offer). These call parameters are then relayed to the other participants using signaling paths via the virtual meeting server 106 to establish secure connections and media channels among the various participants.

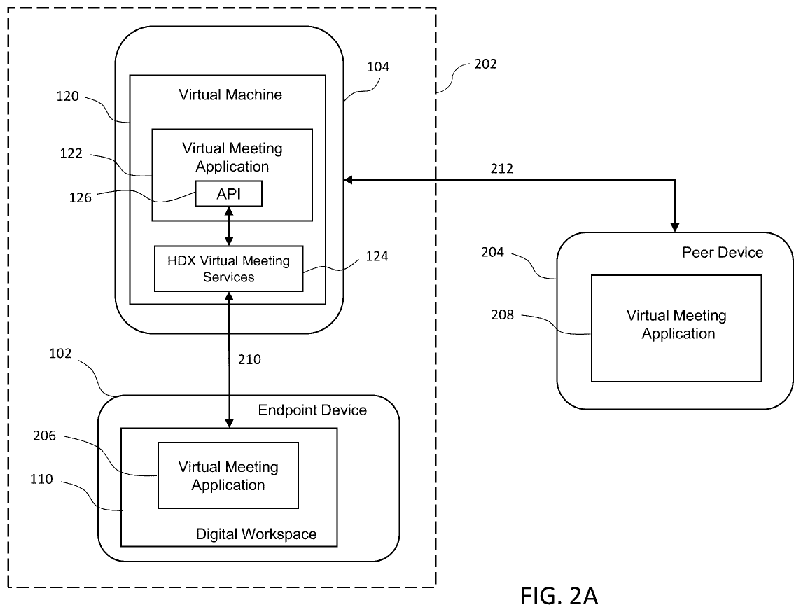

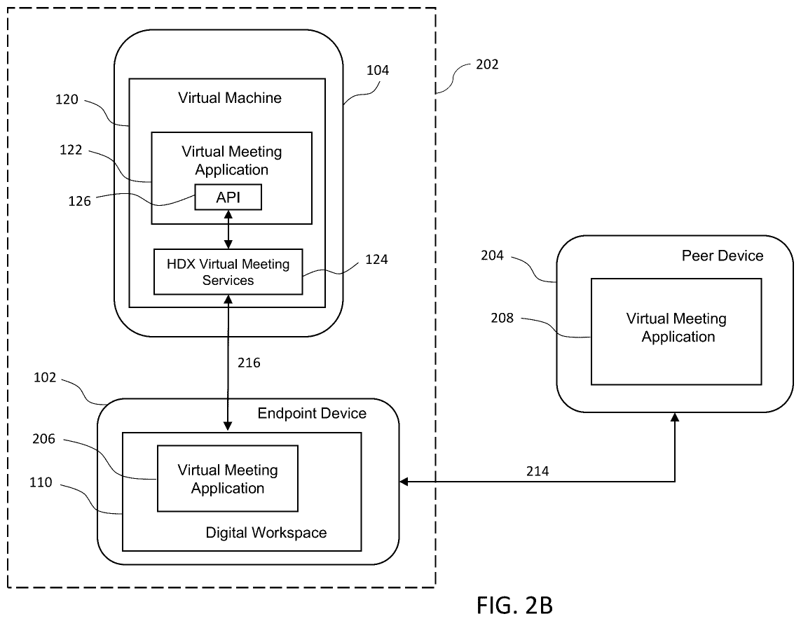

FIGS. 2A and 2B illustrate examples of communications and media channels, also referred to as network paths, between computing devices 202, 204 corresponding to two meeting participants in a virtual meeting session according to certain aspects. In the illustrated example, a first computing device 202 is a distributed computing system, such as the distributed computing system 100 discussed above with reference to FIG. 1. The second computing device 204 (also referred to as the peer device 204) may be a physical computing device, such as a desktop computer, laptop computer, tablet, or smartphone, for example, as shown, but may also be a distributed computing system in other examples. Users of each of the computing devices 202, 204 may access the virtual meeting session through instances of a virtual meeting application 206, 208 provided on the computing devices 202, 204, as shown. In the case of the distributed computing device 202, the instance of the virtual meeting application 206 corresponds to a rendering of the virtual meeting application 122 accessed via the digital workspace app 110, as discussed above.

Referring to FIG. 2A, in certain configurations of the distributed computing device 202, media data corresponding to the virtual meeting session may be exchanged between the endpoint 102 and the peer device 204 over an indirect network path via the virtual environment 104, and in particular, via the virtual machine 120. The media data may include audio and/or video data corresponding to the virtual meeting session. This indirect network path includes a combination of a first network path 210 between the endpoint 102 and the virtual machine 120, and a second network path 212 between the virtual machine 120 and the peer device 204. When the media data is exchanged between the endpoint 102 and the peer device 204 via the indirect network path 210, 212, the virtual machine 120 may handle various multimedia tasks associated with the exchange of the media data, such as formatting the media data, encoding and decoding the data for transmission/reception, etc. Thus, the bulk of the computing load associated with the exchange of the media data is handled by the virtual machine 120.

According to various examples, for a virtual meeting application 122 hosted within a virtual environment and provided via the digital workspace app 110, real-time communication (RTC), particularly WebRTC in certain examples, can be implemented by the HDX services 124 and HDX engine 112 to optimize the audio and/or video performance. In computing environments, RTC is a collection of software protocols and hardware designed to provide responses to communication events within a guaranteed time constraint, often on the order of several milliseconds or less. RTC is useful for efficient messaging frameworks, such as text messaging, telephony, live video conferencing, screen sharing, control and monitoring of remote devices, location-based services, medical patient monitoring, and other applications requiring low latency communications. There are several existing RTC protocols. For example, WebRTC is a protocol that provides web browsers and mobile applications with RTC via APIs. WebRTC enables direct, peer-to-peer communication, which limits or eliminates delays that are potentially introduced by intermediary software and hardware. WebRTC applications can create bi-directional audio, video, and data connections over ephemeral User Datagram Protocol (UDP) ports between two WebRTC-capable devices, such as between two web browsers on a computer or smartphone, or between two dedicated WebRTC appliances (e.g., various thin clients such as voice-over-internet phones or Internet of Things (IoT) devices), or between the computer and a dedicated appliance.

Accordingly, referring to FIG. 2B, in certain circumstances, the distributed computing device 202 can be configured to “offload” the media data for the virtual meeting session from being transmitted via the virtual machine 120 to a direct network path 214 between the endpoint 102 and the peer device 204. In this instance, various control data corresponding to the virtual meeting session may still be communicated between the endpoint 102 and the virtual machine 120 over a network connection 216; however, the media data (which typically may consume far more bandwidth or resources than the control data) may be exchanged between the two computing devices 202, 204 via the direct network path 214. This arrangement may reduce the consumption of computing and network processing resources on the virtual environment 104. However, it increases the computing load at the endpoint 102, since the endpoint handles the multimedia tasks associated with the exchange of the media data.

WebRTC can use peer-to-peer UDP connections to traverse the network for communication directly between peer devices (e.g., between the endpoint 102 and the peer device 204). However, in some cases these peer-to-peer communications are relayed through intermediary services due to restrictions imposed by network firewalls or other products, and in some other cases the peers do not reside in the public Internet but rather in private address spaces behind Network Address Translators (NATs). When the computing device of one meeting participant (e.g., either the endpoint device 102 or the peer device 204) is behind a NAT, the computing device(s) of other meeting participants rely on a relay to traverse the NAT. For example, WebRTC applications running in a web browser can utilize a list of Traversal Using Relays around NAT (TURN) servers that assist in the traversal of NATs or firewalls. The TURN server relays traffic from one peer to another, after the TURN server receives a request from the WebRTC client to relay that traffic. Thus, a TURN server can extend a UDP socket from the WebRTC client device to the TURN server. Accordingly, those skilled in the art will appreciate, given the benefit of this disclosure, that the direct network path 214 between the endpoint 102 and the peer device 204 need not be strictly “direct” and may include certain intermediary components as discussed above. However, exchanging the media data via the direct network path 214 does not include directing the media data via the virtual machine 120. Thus, as used herein, the term “indirect” network path refers to one that includes the virtual machine 120 (as shown in FIG. 2A, for example), whereas the term “direct” network path refers to one that does not include the virtual machine 120 (as shown in FIG. 2B, for example).

Although using the direct network path 214 for media data exchange can be beneficial in many circumstances, there are some instances in which this configuration does not provide a better user experience in the virtual meeting than using the indirect network path configuration of FIG. 2A. For example, in situations where the computing and/or networking resources of the endpoint 102 are already operating at or near capacity, whereas the virtual machine 120 has sufficient resources available to serve additional multimedia tasks, better performance may be achieved by having the virtual machine 120 handle tasks associated with exchanging the media data (i.e., using the indirect network path 210, 212), rather than the endpoint 102 (as is the case for the direct path configuration). In another example, if the network quality of the connection(s) corresponding to the direct path 214 between the endpoint 102 and the peer device 204 is poor, whereas the network quality of the connection(s) between the virtual machine 120 and the peer device (network path 212), as well as the network quality of the network path 210 between the virtual machine 120 and the endpoint 102 are good, using the indirect path 210, 212 may provide better performance than using the direct path 214.

Accordingly, aspects and embodiments are directed to configuring the distributed computing device 202 to monitor and evaluate conditions (such as network quality conditions in the various network paths, computing loads on the endpoint 102 and the virtual machine 120, the availability of computing resources for multimedia tasks at the endpoint 102 and the virtual machine 120) during a virtual meeting session and dynamically switch between using the direct path 214 and the indirect path 210, 212 for media data exchange based on real-time performance. Various virtual meeting applications, including Microsoft Teams®, have the capability to support multipath media channels simultaneously and seamlessly transfer data exchange between different paths. Aspects and embodiments leverage this capability to implement dynamic switching of the media data exchange channel between the direct and indirect paths, as discussed further below.

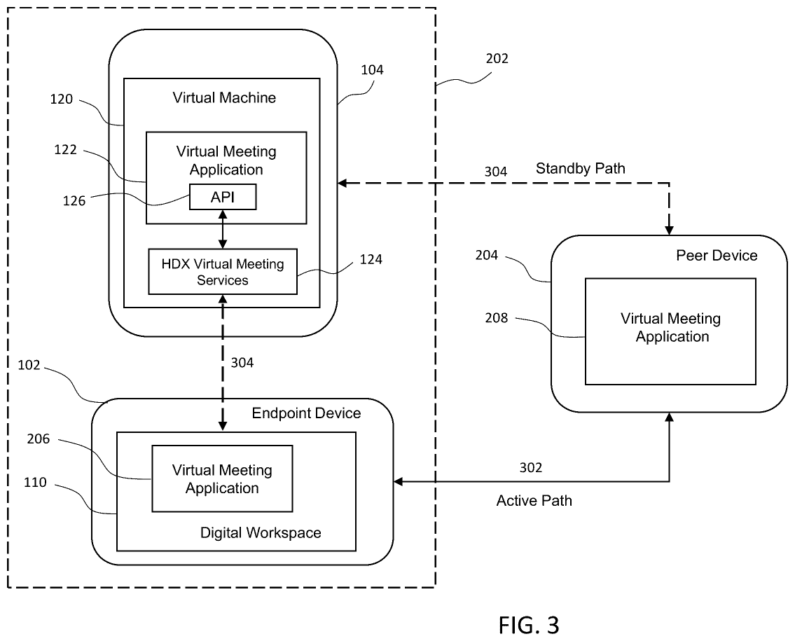

Referring to FIG. 3, according to certain aspects, dynamic path switching may be implemented by operating the indirect path 210, 212 of FIG. 2A and the direct path 214 of FIG. 2B simultaneously as an active network connection and a standby network connection. In the example shown in the FIG. 3, the active network connection 302 corresponds to the direct path (214 in FIG. 2B) and the standby network connection 304 corresponds to the indirect path (210, 212 in FIG. 2A); however, those skilled in the art will appreciate, given the benefit of this disclosure, that at any time, the active network connection 302 may correspond instead to the indirect path and the standby network connection may correspond to the direct path, as discussed below. During a virtual meeting session, the active network connection 302 carries the media data corresponding to the virtual meeting session. The computing device 202 may be configured to monitor one or more parameters associated with the active network connection 302 that may serve as performance metrics indicative of the performance or media quality (e.g., audio and/or video quality) of the virtual meeting session. Periodically, test data may be transmitted via the standby network connection to measure one or more parameters associated with the standby network connection to determine whether the performance of the virtual meeting session would be improved if the standby network connection were used to exchange the media data instead of the active network connection. The active network connection 302 thus can be mapped to the direct path 214 or the indirect path 210, 212 at any time during the virtual meeting session based on the measurements that indicate which path would likely provide better session quality. This mapping may be fully dynamic across the virtual meeting session.

According to certain embodiments, the one or more parameters that may be monitored and measured for each of the active network connection 302 and the standby network connection 304 may include one or more parameters that relate to the network quality of the connections and/or to the media quality (e.g., audio and/or video quality) of the virtual meeting session. For example, parameters relating to the media quality may include frames per second of the transmitted data, resolution of the media data rendered in the virtual meeting application 206, 208, packet loss rate, and round-trip time (RTT) for the data transmission. For the active network connection 302, these parameters may be measured for the media data as it is exchanged between the computing devices 202, 204 during the virtual meeting session. As discussed above, for the standby network connection 304, these parameters may be measured for test data that is periodically transmitted over the standby connection 304. In some instances, the test data may be a copy of the media data corresponding to the active virtual meeting session. In other instances, the test data may be representative of typical virtual meeting media data, for example, but may not correspond directly to the media data for the active virtual meeting session. In certain examples, measurement data for these, and/or other, parameters/performance metrics associated with each of the active network connection 302 and the standby network connection 304 may be obtained through a WebRTC interface. In other examples, the virtual meeting application 122 may provide information about these, and/or other, parameters. For example, where the virtual meeting session is a Microsoft Teams® session, information about these parameters may be obtained from a Teams® health module that is associated with the Microsoft Teams® application.

Further parameters that may be evaluated include a processor and/or memory load on each of the virtual machine 120 and the endpoint 102. These parameters may help to indicate and determine whether the endpoint 102 or the virtual machine 120 has more resources available for handling the multimedia tasks associated with exchanging the media data between the endpoint 102 and the peer device 204. Another parameter that may be evaluated in certain examples is the network quality of the network connection 210 between the HDX meeting services 124 and the HDX engine 112, which may only be used for media data exchange when the indirect network path 210, 212 corresponds to the active network connection 302. In certain examples, the network quality of the HDX network connection 210 may be evaluated by measuring the round-trip time (RTT_{HDX}) for data transmission over this network connection.

As discussed above, the virtual meeting application 122 may support simultaneous transmission of data over multiple paths. Accordingly, the test data can be periodically sent over the standby network connection 304 without disrupting or interfering with the virtual meeting session. This allows the standby network connection 304 to be monitored in real-time, in combination with real-time monitoring of the active network connection 302. Accordingly, the quality or performance of both connections can be compared during the active virtual meeting session to allow for dynamic mapping and remapping of the active network connection to the better-performing one of the direct path 214 and the indirect path 210, 212.

According to certain examples, an overall quality determination may be made for each of the active network connection 302 and the standby network connection 304 based on a combination of the measured parameters for each connection. For example, the computing device 202 may calculate a quality score associated with each of the active network connection 302 and the standby network connection 304 based on a combination of the measured parameters. In some examples, each of the measured parameters associated with each of the active network connection and the standby network connection may be given an associated weighting factor that determines a contribution of each parameter to the quality score for the respective network connection. The weighting factors may be tunable to weight different parameters differently according to different user preferences, system conditions or configurations, or other considerations. For example, historical information regarding the impact of various parameters on the quality of the virtual meeting session may be used to weight those parameters having greater impact higher than other parameters with lesser impact. In certain examples, the computing device 202 provides a user interface configured to receive input specifying values of the weighting factors such that users may configure the system according to their own preferences. In other examples, the computing device 202 may be programmed with certain weighting factors that may either be adjusted by a system administrator or by the computing device 202 itself using machine learning processes, for example.

Table 1 below shows an example of parameters and weighting factors that may be used in some instances. It is to be appreciated that the example of Table 1 is for the purposes of illustration only and not intended to be limiting. As discussed above, various other parameters may be considered and there are numerous variations in the weighting factors that can be implemented, as will be appreciated by those skilled in the art, given the benefit of this disclosure.

TABLE 1

| | Direct Path | Indirect Path | |
|---|---|---|---|
| Parameter | (214) | (210, 212) | Weight |
| Frames per Second | 16 | 32 | 0.2 |
| Resolution | 800 x 600 | 800 x 600 | 0.2 |
| Packet Loss Rate | 0% | 0% | 0.2 |
| RTTVM | 90 ms | 50 ms | 0.3 |
| Processor and | 15% | 14% | 0.1 |
| Memory Load | | | |
| Overall Score | 0 | 0.5 | |

Referring again to FIGS. 2A, 2B, and 3, in Table 1 above, RTT_{VM} refers to the round-trip time for the network path between the peer device 204, and the endpoint 102 for the direct path 214 and for the network path between the virtual machine 120 and the peer device 204 for the indirect path (path segment 212). Thus, in certain examples, the RTT_{VM} parameter excludes the HDX network connection 210 that is only used for media data transmission in the indirect path. The round-trip time is measured in milliseconds (ms). As will be appreciated by those skilled in the art, different parameters (or performance metrics) may be measured in different units. Accordingly, any of various processes may be applied to consider the different parameters in combination and obtain the overall quality score for each path. In the example of Table 1, for each parameter, the weight is applied only to the higher performing path for that parameter. The corresponding weights are then added together to arrive at the overall score for each path. This may be equivalent to comparing the measurements from each path for a particular parameter, replacing the better measurement with a one (1) and the poorer measurement with a zero (0), and then multiplying the weigh by the corresponding 1 or 0 and summing the results. Table 2 illustrates an example of this approach applied to the example of Table 1.

TABLE 2

| | | Result of | | Result of | |
|---|---|---|---|---|---|
| | Direct Path | Comparison | Indirect Path | Comparison | |
| | (214) | for Direct | (210, 212) | for Indirect | |
| Parameter | Measurement | Path | Measurement | Path | Weight |
| Frames per Second | 16 | 0 | 32 | 1 | 0.2 |
| Resolution | 800 x 600 | 0 | 800 x 600 | 0 | 0.2 |
| Packet Loss Rate | 0% | 0 | 0% | 0 | 0.2 |
| RTTVM | 90 ms | 0 | 50 ms | 1 | 0.3 |
| Processor and Memory Load | 15% | 0 | 14% | 0 | 0.1 |
| Overall Score | | 0 | | 0.5 | |

In the example of Table 2, it can be seen that for the parameter Frames per Second, the indirect path 210, 212 has better performance. Accordingly, the direct path measurement is replaced with 0 and the indirect path measurement is replaced with 1. The same occurs for the RTT_{VM} parameter. In this example (and the example of Table 1), if the two measurements are the same, or similar within a certain predetermined threshold, the measurements of that parameter for both paths are replaced with 0, as shown in Table 2. The threshold values for similarity between measurements of each parameter may be configurable, and may be adjusted by the computing device 202, by a system administrator, or by a user of the computing device 202, for example. Thus, in the example of Tables 1 and 2, it can be seen that the indirect path acquires an overall score of 0.5 (1×0.2 for the Frames per Second parameter and 1×0.3 for the RTT_{VM} parameter), whereas the direct path acquires a score of 0. Thus, the comparison of these parameters for the two paths in this example indicates that the indirect path 210, 212 may provide better performance/quality for the virtual meeting session. Accordingly, if the active network connection 302 is presently the direct path 214 (as in the example illustrated in FIG. 3), comparison of the overall quality score for the two paths in this example may indicate that switching the active network connection 302 to the indirect path 210, 212 may be warranted, as discussed further below.

Those skilled in the art will appreciate, given the benefit of this disclosure, that the weights shown in Tables 1 and 2 are arbitrary, and that numerous other approaches for determining the overall score for each path may be implemented. For example, the weighting factors may be applied to all parameters, not only to those differing by more than a threshold amount. In other examples, sliding scales may be applied to parameter measurements (rather than replacing each measurement with 0 or 1) based on the difference in performance on that parameter in each path, such that parameters that are significantly different may be weighted for heavily than those that are more similar. Numerous other examples and approaches may be implemented, as will be appreciated by those skilled in the art, given the benefit of this disclosure. Accordingly, the examples shown in Tables 1 and 2 are merely illustrative and not intended to be limiting.

According to certain examples, the computing device 202 may make a determination whether or not to switch the active network connection 302 from one path (direct or indirect) to the other based on the quality scores obtained for each path. For example, if a second quality score for the path (direct or indirect) currently mapped to the standby network connection 304 sufficiently exceeds a first quality score for the path currently mapped to the active network connection 302, the computing device 202 may cause the active network connection 302 to be remapped (switched) to the path with the higher quality score. In some instances, for the second quality score to sufficiently exceed the first quality score, the second quality score may simply be higher than the first quality score. In other instances, for the second quality score to sufficiently exceed the first quality score may mean that the second quality exceeds the first quality score by at least a predetermine threshold amount. The threshold amount may be set during a system and process configuration, or may be tunable and may be determined by the computing device 202, a system administrator, or the user in some examples.

In other examples, if the quality scores indicate that a remapping of the active network connection may be desirable, the computing device 202 may perform one or more additional measurements prior to making a final determination as to whether or not to switch the active network connection 302 from one path (direct or indirect) to the other. For example, the computing device 202 may determine an indication of standby network quality based on latency conditions associated with the standby network connection. Thus, in certain examples, the determination whether or not to switch (or remap) the active network connection 302 from its current network path (direct or indirect) to the other available network path maybe a two-step process. In a first step, the computing device 202 may evaluate one or more parameters associated with each of the direct and indirect network paths, as discussed above, to determine first and second quality scores associated with the active network connection 302 and the standby network connection 304, respectively. If the second quality score for the standby network connection 304 exceeds the first quality score for the active network connection 302, optionally by a predetermined threshold amount, the computing device 202 may proceed to a second step in which network quality measurements are performed. In particular, as discussed above, the computing device 202 may determine latency conditions associated with the standby network connection 304 as an indication of the network quality of the standby network connection. Based on the indication of the standby network quality exceeding a second predetermined threshold value, the computing device 202 may switch the active and standby network connections.

According to certain examples, the second step of determining an indication of the network quality of the standby network connection may only be performed if the following conditions are both met: (i) the quality scores indicate that the quality of the indirect path is better than that of the direct path; and (ii) the active network connection 302 currently corresponds to the direct path 214. As discussed above, in certain examples, one of the parameters associated with the active and standby network connections that may be monitored and measured is the round-trip time, RTT_{VM}, which is a metric associated with network quality. Accordingly, in such examples, the second step of determining an indication of the network quality of the standby network connection may include evaluating the network quality for the HDX network connection 210, which, as discussed above, is only used for media data transmission in the indirect network path. Therefore, this step may be performed if the standby network connection 304 is the indirect network path. The HDX network quality may be evaluated by measuring the round-trip time, RTT_{HDX} for data transmission (media data or test data) over the HDX network connection 210. In terms of latency, or RTT, the network quality may be expressed as the total delay in the path. For the direct path 214 and the indirect path 210, 212 the network quality is indicated, respectively by:

$${Delay\_}_{direct} = {RTT}_{VM \_ direct}$$

$${Delay\_}_{indirect} = {RTT}_{VM \_ indirect} + {RTT}_{HDX}$$

In one example, the computing device 202 may determine to switch the active network connection 302 to the standby network connection 304, and vice versa, based on the following condition:

$$( {Delay}_{a c t i v e} - {Delay}_{s t a n d b y} ) / {Delay}_{a c t i v e} > Threshold \qquad ( Equation 1 )$$

This switching threshold may be a tunable ratio in a range from zero (0) to one (1), for example. In certain examples, the computing system 202 may tune the switching threshold based on one or more factors, such as historical information regarding the effect of network latency on the performance/quality of the virtual meeting session, for example. In other examples, a system administrator or user may tune the switching threshold based on preferences or other system considerations.

Thus, based on various indicators of the quality of a virtual meeting session, which may be monitored in real-time as discussed above, the computing system 202 can make a determination as to whether the current active network connection 302 should be switched with the standby network connection 304 so as to improve the quality of the virtual meeting session. As discussed above, this path switching may be performed dynamically during the virtual meeting session, thus avoiding the need for a user or system administrator to manually select one configuration or other at, or prior to, the start of the virtual meeting session.

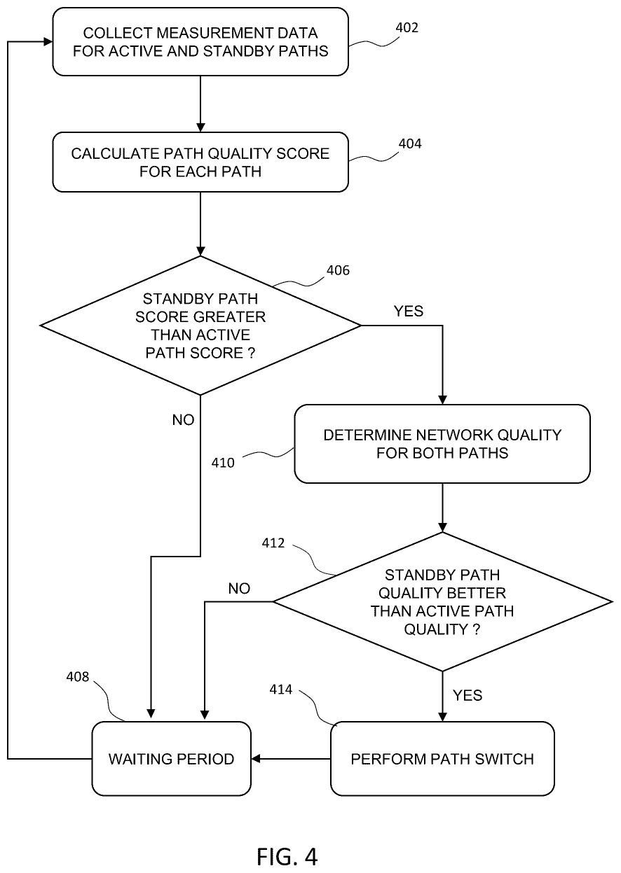

Referring to FIG. 4, there is illustrated a flow diagram of one example of a method of dynamic path switching that may be implemented by the computing device 202 according to certain embodiments.

In step 402, the computing device 202 may collect measurement data for one or more parameters associated with each of the active network connection 302 and the standby network connection 304. In certain examples, the computing device 202 may continually monitor the one or more parameters associated with the active network connection 302 during the virtual meeting session. In other examples, the computing system 202 may periodically (e.g., every few minutes) collect measurement data for the one or more parameters associated with the active network connection 302. As discussed above, measurement data may be periodically collected for the one or more parameters associated with the standby network connection 304 by periodically transmitting test data over the standby network connection. The test data may be a copy of the media data corresponding to the virtual meeting session.

In step 404, the computing device 202 may determine a first quality score for the active network connection 302 based on the measurement data collected for the one or more parameters associated with the active network connection, and may determine a second quality score for the standby network connection 304 based on the measurement data collected for the one or more parameters associated with the standby network connection. As discussed above, the quality score for each of the network connections may be based on a weighted combination of the various measured parameters for each network connection.

In step 406, the computing system may determine whether the second quality score for the standby network connection 304 exceeds the first quality score for the active network connection 302, optionally by at least a predetermined threshold amount/value. If not, no path switching may be needed at present. According to certain examples, the computing device 202 may wait for a predetermined time period (e.g., a few minutes, such as 5 minutes or 10 minutes, for example) in step 408, and then proceed to repeat the measurement collection step 402.

If the second quality score for the standby network connection 304 exceeds the first quality score for the active network connection 302 by at least a predetermined threshold amount/value (indicating that a path switch may be desirable), the computing system may proceed to determine an indicator of network quality for each of the active network connection 302 and the standby network connection 304 (step 410). This indicator may be based on latency conditions in the network connections, for example. As discussed above, in certain examples, one of the parameters measured during the measurement collection step 402 may be an indicator of the network quality, such as the round-trip time, RTT_{VM}. As also discussed above, for the direct network path 214, the network quality, or latency conditions, may be indicated by RTT_{VM}, and therefore there may be no need to further determine network quality conditions for the direct path 214 in step 410. In other examples, as discussed above, step 410 may only be performed if the active network connection 302 is presently the direct network path 214. As discussed above, the HDX network connection 210 is only used for media data transfer in the indirect path. In addition, the HDX connection 210 necessarily adds latency to the already measured RTT_{VM} for the indirect path (Delay__{indirect}=RTT_{VM_indirect}+RTT_{HDX}). Accordingly, if the current active network connection corresponds to the indirect path 210, 212, and the comparisons of the quality scores indicates that a switch of the active network connection from the indirect path to the direct path may be warranted, there may be no need to measure RTT_{HDX} as the HDX network connection 210 is not used for media data transfer in the direct path 214. Thus, in this circumstance, the conditions of the HDX network connection 210 may not influence the determination that a path switch may be desirable. Under these circumstances, the computing device 202 may proceed to determine that the active and standby network connections should be switched without the need to perform step 410. Accordingly, in such cases, the computing device 202 may proceed directly from step 406 to step 414 and remap the active network connection 302 from the indirect network path 210, 212 to the direct path 214.

In examples in which step 410 is performed, the computing device 202 may then determine whether the network quality of the standby network connection 304 is better than that of the active network connection 302 (step 412). As discussed above, in certain examples, this determination may use the formula set forth in Equation (1) above. If the network quality of the standby network connection 304 is sufficiently better than that of the active network connection 302 (or the switched threshold specified in Equation (1) is met), the computing device 202 may proceed to step 414 of performing the path switching. Thus, the active network connection 302 may be remapped to the other of the direct or indirect paths, and the standby network connection 304 is oppositely remapped and becomes the new active network connection. As discussed above, this switching may be performed dynamically and seamlessly at any time during the virtual meeting session.

If the network quality of the standby network connection does not meet the switching threshold, the computing system may not perform the path switching, and instead wait for the predetermined time period in step 408, before proceeding to repeat the measurement collection step 402 and restart the method flow shown in FIG. 4. Similarly, after performing the path switching in step 414, the computing system may wait for the predetermined time period in step 408, before proceeding to restart the method at step 402. Waiting for the predetermined time period in step 408 ensures that the system will not perform the path switching too frequently based on minor fluctuations in one or more parameters or network conditions.

Thus, aspects and embodiments provide apparatus and methods for improving virtual meeting performance by monitoring system conditions in real time and dynamically switching between different network paths to optimize media performance based on available resources and conditions. Although discussed in the context of a virtual meeting session, those skilled in the art, given the benefit of this disclosure, may appreciate that the principles and aspects discussed herein may be applied to other applications in a distributed workspace system in which media data is exchanged between the endpoint 102 and one or more peer devices 304.

### Computer System Configured for Virtual Meeting Optimization

FIG. 5 is a block diagram of an example of a system 500 for implementing adaptive network path switching, in accordance with aspects of the present disclosure. The system 500 includes a virtualization server 510 (such as the virtualization environment 104 discussed above) that is capable of hosting virtual machine(s) and/or carrying out embodiments of the methods disclosed herein. As shown in FIG. 5, the virtualization server 510 is configured to host the virtual machine 120 and a server virtualization agent 512. The virtualization server 510 may comprise one or more of a variety of suitable computing devices, such as a desktop computer, a laptop computer, a workstation, an enterprise-class server computer, a tablet computer, or any other device capable of supporting the functionalities disclosed herein. A combination of different devices may be used in certain examples. As illustrated in FIG. 5, the virtualization server 510 includes one or more software programs configured to implement certain of the functionalities disclosed herein as well as hardware capable of enabling such implementation.

The system 500 further includes an endpoint 520 and a plurality of application servers 530. A user may be associated with the endpoint 520. The user's association with the endpoint 520 may exist by virtue of, for example, the user being logged into or authenticated to the endpoint 520. In the example illustrated in FIG. 5, the application servers include a SaaS application server 532, a web application server 534, and an enterprise application server 536, although servers hosting any other suitable existing or subsequently developed applications can be used as well, including proprietary applications and desktop applications. While only one endpoint 520 and three examples of application servers 530 are illustrated in FIG. 5 for clarity, it will be appreciated that, in general, the system 500 is capable of analyzing interactions between an arbitrary number of endpoints and an arbitrary number of application servers.

The virtualization server 510, the endpoint 520, and the application servers 530 communicate with each other via a network 540. The network 540 may be a public network (such as the Internet) or a private network (such as a corporate intranet or other network with restricted access). Other examples may have fewer or more communication paths, networks, subcomponents, and/or resources depending on the granularity of a particular implementation. For example, in some implementations at least a portion of the application functionality is provided by one or more applications hosted locally at an endpoint. Thus references to the application servers 530 should be understood as encompassing applications that are locally hosted at one or more endpoints. It should therefore be appreciated that the examples described and illustrated herein are not intended to be limited to the provision or exclusion of any particular services and/or resources.

As noted above, in certain examples the endpoint 520 can be a computing device that is used by the user. Examples of such a computing device include but are not limited to, a desktop computer, a laptop computer, a tablet computer, and a smartphone. The virtualization server 510 and its components are configured to interact with a plurality of endpoints. In certain examples, the user interacts with a plurality of workspace applications 522 that are accessible through a digital workspace 524, which can serve as a digital workspace app 110 discussed above with reference to FIG. 1. Any microapps can be made available to the user through the digital workspace 524, thereby allowing the user to view information and perform actions without launching (or switching context to) the underlying workspace applications 522. The workspace applications 522 can be provided by the application servers 530 and/or can be provided locally at the endpoint 520. The workspace applications 522 can include any of a wide variety of applications, including, but not limited to, a scheduling application, a task assignment/management application, a billing application, a word processing application, a spreadsheet application, a coding application, a chat application, an email client application, a calendar application, a conferencing application, a file management application, a virtual meeting application (such as the virtual meeting application 122 discussed above), and other similar applications that a user may interact with during a distributed workspace session. To enable the endpoint 520 to participate in a virtualization infrastructure facilitated by the broker computer 550 and involving the server virtualization agent 512 as discussed herein, the endpoint 520 also hosts a client virtualization agent 526.

The broker computer 550 is configured to act as an intermediary between the client virtualization agent 526 and the server virtualization agent 512 within the virtualization infrastructure. In some examples, the broker computer 550 registers virtual resources offered by server virtualization agents, such as the server virtualization agent 512. In these examples, the broker computer 550 is also configured to receive requests for virtual resources from client virtualization agents, such as the client virtualization agent 526, and to establish virtual computing sessions involving the client virtualization agent 526 and the server virtualization agent 512.

### Sample Computing Platform

FIG. 6 is a block diagram of a computing platform 600 configured to implement various systems and processes in accordance with examples disclosed herein.

The endpoint 102, computing device 108, and/or virtualization environment 104 are examples of computing systems that may be implemented using examples of the computing platform 600. The endpoint device 102 and the virtualization environment 104 can be implemented within any computing or processing environment with any type of physical or virtual machine or set of physical and virtual machines that can have suitable hardware and/or software capable of operating as described herein. In some examples, some components of the computing device can be implemented virtually (e.g., using a combination of hardware and software), such as to provide the virtual machine 120 to the digital workspace app 110 of the endpoint device 102, where the virtual machine 120 emulates certain processing functions of the endpoint computing system 102 using hardware components of the endpoint computing system 102 (e.g., processors, network communications hardware, I/O devices, etc.).

The computing platform 600 includes one or more processor(s) 610, volatile memory 620 (e.g., random access memory (RAM)), non-volatile memory 630, one or more network or communication interfaces 640, a user interface (UI) 650, and a communications bus 660. The computing platform 600 may also be referred to as an endpoint device, computer, computing device, server, or computer system.

The processor(s) 610 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals. In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor can be analog, digital, or mixed. In some examples, the processor can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The non-volatile (non-transitory) memory 630 includes one or more machine-readable mediums that can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof.

The non-volatile memory 630 stores an operating system (OS) 632, one or more applications or programs 634, and data 636. The OS 632 and the application(s) 634 include sequences of instructions that are encoded for execution by processor(s) 610. Execution of these instructions results in manipulated data. Prior to their execution, the instructions can be copied to the volatile memory 620. In some examples, the volatile memory 620 can include one or more types of RAM and/or a cache memory that can offer a faster response time than a main memory. Data can be entered through the user interface 650 or received from the other I/O device(s), such as the network interface 640. The various elements of the computing platform device 600 can communicate with one another via the communications bus 660.

The user interface 650 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The network interface(s) 640 can include one or more interfaces to enable the computing platform 600 to access a computer network 670 (e.g., the network 106 discussed above) such as a Local Area Network (LAN), a Wide Area Network (WAN), a Personal Area Network (PAN), or the Internet through a variety of wired and/or wireless connections, including cellular connections. In some examples, the network 670 may allow for communication with other computing platforms 680 to enable distributed computing as discussed herein.

In various examples, the computing device 600 can execute an application on behalf of a user of an endpoint device. For example, the computing device 600 can execute one or more virtual machines managed by a hypervisor. Each virtual machine can provide an execution session within which applications execute on behalf of a user or an endpoint device 102, such as a hosted desktop session. The computing device 600 can also execute a terminal services session to provide a hosted desktop environment. The computing device 600 can provide access to a remote computing environment including one or more applications, one or more desktop applications, and one or more desktop sessions in which one or more applications can execute.

The illustrated computing platform 600 is shown merely as an example computing device and can be implemented by any computing or processing environment with any type of machine or set of machines that can have suitable hardware and/or software capable of operating as described herein.

### CONCLUSION

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings of various embodiments are presented by way of example only. These examples are not intended to be exhaustive or to limit the invention to the precise forms disclosed. The methods and apparatuses are capable of implementation in other embodiments and of being practiced or of being carried out in various ways.

For example, the processes disclosed herein depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms. The scope of the invention should be determined from proper construction of the appended claims, and their equivalents.

1. A method of improving performance in a virtual meeting session in a distributed workspace system, the method comprising:
transmitting media data corresponding to the virtual meeting session over an active network connection between first and second computing devices corresponding, respectively, to first and second meeting participants in the virtual meeting session, wherein the first computing device is part of the distributed workspace system;
determining a first quality score for the active network connection based on one or more first parameters associated with the active network connection;
periodically transmitting test data over a standby network connection between the first and second computing devices;
determining a second quality score for the standby network connection based on one or more second parameters associated with the standby network connection; and
based on determining that the second quality score exceeds the first quality score by at least a first predetermined threshold value:
determining an indication of standby network quality based on latency conditions associated with the standby network connection; and
based on the indication of the standby network quality exceeding a second predetermined threshold value, switching the active and standby network connections such that the standby network connection becomes a new active network connection and the active network connection becomes a new standby network connection, and transmitting the media data over the new active network connection.

2. The method of claim 1, further comprising accessing the virtual meeting session on the first computing device, including:
accessing a virtual machine through a digital workspace application running on the first computing device, the virtual machine hosting a virtual meeting application configured to connect the first meeting participant to the virtual meeting session.

3. The method of claim 2, wherein the active network connection corresponds to one of either a direct network path between the first and second computing devices or an indirect network path between the first and second computing devices, and wherein the standby network connection corresponds to the other of the direct network path and the indirect network path; and
wherein the indirect network path comprises a combination of a first network path between the first computing device and the virtual machine and a second network path between the virtual machine and the second computing device.

4. The method of claim 3, wherein determining the first quality score comprises monitoring the one or more first parameters during the virtual meeting session.

5. The method of claim 4, wherein monitoring the one or more first parameters comprises monitoring at least one of frames per second of the media data transmitted over the active network connection, resolution of the media data transmitted over the active network connection, packet loss rate associated with the media data transmitted over the active network connection, a network round-trip time for the active network connection, or processor load for at least one processor of the distributed workspace system.

6. The method of claim 5, wherein, when the active network connection corresponds to the direct network path, monitoring the one or more first parameters includes monitoring the processor load for a processor of the first computing device.

7. The method of claim 4, wherein determining the second quality score comprises monitoring the one or more second parameters during periodic transmission of the test data over the standby network connection.

8. The method of claim 7, wherein monitoring the one or more second parameters comprises monitoring at least one of frames per second of the test data transmitted over the standby network connection, resolution of the test data transmitted over the standby network connection, packet loss rate associated with the test data transmitted over the standby network connection, a network round-trip time for the standby network connection, or processor load for at least one processor of the distributed workspace system.

9. The method of claim 8, wherein, when the standby network connection corresponds to the indirect network path, monitoring the one or more second parameters includes at least one of monitoring network round-trip time between the virtual machine and the second computing device, the processor load for at least one processor operating the virtual machine, or network round-trip time between the first computing device and the virtual machine.

10. The method of claim 3, wherein determining the indication of standby network quality based on the latency conditions associated with the standby network connection comprises measuring a round-trip network connection time of the standby network connection during periodic transmission of the test data over the standby network connection.

11. A distributed computer system comprising:
a memory storing a plurality of instructions;
at least one network interface; and
at least one processor coupled to the memory and to the at least one network interface and configured execute the plurality of instructions to:
operate a virtual meeting session;
establish, via the at least one network interface, an active network connection between a first computing device of the distributed computer system and a peer computing device;
transmit, via the active network connection, media data corresponding to the virtual meeting session from the first computing device to the peer computing device;
determine a first quality score for the active network connection based on one or more first parameters associated with the active network connection;
periodically establish a standby network connection between the first computing device and the peer computing device;
transmit test data over the standby network connection;
determine a second quality score for the standby network connection based on one or more second parameters associated with the standby network connection; and
based on determining that the second quality score exceeds the first quality score by at least a first predetermined threshold value:
determine an indication of standby network quality based on latency conditions associated with the standby network connection; and
based on the indication of the standby network quality exceeding a second predetermined threshold value, (i) establish the standby network connection as a new active network connection between the first computing device and the peer computing device, (ii) disable the active network connection, and (iii) transmit, via the new active network connection, the media data corresponding to the virtual meeting session from the first computing device to the peer computing device.

12. The distributed computer system of claim 11, wherein to operate the virtual meeting session, the first computing device is configured to access a virtual machine through a digital workspace application running on the first computing device, the virtual machine hosting a virtual meeting application.

13. The distributed computer system of claim 12, wherein the active network connection corresponds to one of either a direct network path between the first computing device and the peer computing device or an indirect network path between the first computing device and the peer computing device, and wherein the standby network connection corresponds to the other of the direct network path and the indirect network path; and
wherein the indirect network path comprises a combination of a first network path between the first computing device and the virtual machine and a second network path between the virtual machine and the second computing device.

14. The distributed computer system of claim 13, wherein to determine the first quality score the at least one processor is configured to monitor the one or more first parameters during the virtual meeting session.

15. The distributed computer system of claim 14, wherein to monitor the one or more first parameters the at least one processor is configured to monitor at least one of frames per second of the media data transmitted over the active network connection, resolution of the media data transmitted over the active network connection, packet loss rate associated with the media data transmitted over the active network connection, a network round-trip time for the active network connection, or a computing load on the at least one processor.

16. The distributed computer system of claim 14, wherein to determine the second quality score the at least one processor is configured to monitor the one or more second parameters during transmission of the test data over the standby network connection.

17. The distributed computer system of claim 16, wherein to monitor the one or more second parameters the at least one processor is configured to monitor at least one of frames per second of the test data transmitted over the standby network connection, resolution of the test data transmitted over the standby network connection, packet loss rate associated with the media data transmitted over the standby network connection, a network round-trip time for the standby network connection, or a computing load on the at least one processor during temporary transmission of the media data over the standby network connection.

18. The distributed computer system of claim 17, wherein, when the standby network connection corresponds to the indirect network path, to monitor the one or more second parameters the at least one processor is configured to monitor network round-trip time between the virtual machine and the peer computing device and network round-trip time between the first computing device and the virtual machine.

19. The distributed computer system of claim 13, wherein to determine the indication of standby network quality based on the latency conditions associated with the standby network connection, the at least one processor is configured to determine a round-trip network connection time of the standby network connection during periodic transmission of the test data over the standby network connection.

20. A distributed computer system comprising:
a memory storing a plurality of instructions;
at least one network interface;
at least one processor coupled to the memory and to the at least one network interface and configured execute the plurality of instructions;
means for determining that the second quality score exceeds the first quality score by at least a first predetermined threshold value;
means for determining an indication of standby network quality based on latency conditions associated with the standby network connection; and
means for establishing the standby network connection as a new active network connection between the first computing device and the peer computing device;
means for disabling the active network connection; and
means for transmitting, via the new active network connection, the media data corresponding to the virtual meeting session from the first computing device to the peer computing device.
